(19) United States
(12) Patent Application Publication
(10) Pub. No.: US 2019/0188789 A1
(43) Pub. Date: Jun. 20, 2019

(54) METHOD AND SYSTEM FOR SERVICING AND COFUNDING OF INSTALLMENTS

(71) Applicant: Mastercard International Incorporated, Purchase, NY (US)

(72) Inventors: Dominique STEENBEEK, Wavre (BE); Gregory James BARRETT, Ridgefield, CT (US); Anushree Ashutosh PRABHUNE, Stamford (GB)

(73) Assignee: Mastercard International Incorporated, Purchase, NY (US)

(21) Appl. No.: 15/846,403

(22) Filed: Dec. 19, 2017

(51) Int. Cl. G06Q 40/02; G06Q 20/02

(52) U.S. Cl. CPC G06Q 40/025; G06Q 20/027

(57) ABSTRACT

A method for servicing a co-funded installment includes: storing agreement data entries, each related to a co-funding agreement and including a merchant identifier, acquirer identifier, and one or more installment parameters; receiving a transaction message for a payment transaction, the transaction message including a specific merchant identifier, a specific acquirer identifier, and transaction data; identifying at least one agreement data entry where the included merchant identifier corresponds to the specific merchant identifier and where the included acquirer identifier corresponds to the specific acquirer identifier; identifying a plurality of installment terms based on the transaction data and the one or more installment parameters included in one of the at least one identified agreement data entries; and transmitting the identified plurality of installment terms.

### FIELD

The present disclosure relates to the servicing of co-funded installments, specifically the identification and application of an agreement between merchant and/or acquirer and an issuer of a transaction account for enabling a proposed transaction to be converted into an installment under terms of the agreement.

### BACKGROUND

For large purchases, consumers have often been interested in ways to be able to receive an item immediately that is not paid off until a later date. For some items, financing options are available via loans, mortgages, or other similar mechanisms, such as often found when purchasing vehicles or homes. For smaller ticket items, consumers can often use credit cards, where the issuing institution will pay the merchant immediately for a purchase and the consumer will pay back the issuer for all such purchases made over a period of time. In some countries, merchants have also begun to participate in deferred payment plans, selling products to consumers via installments, where a consumer can purchase a product for a down payment and make regular, periodic payments to the merchant to cover the remaining cost of the product. In cases where merchants may be unable to offer installments, and to generally provide additional services to their customers, many issuers have started to provide customers with the opportunity to convert purchases into installments.

For many merchants, especially smaller businesses that lack resources and technology, it may be very beneficial to rely on issuing financial institutions, which often have access to significantly greater resources and capabilities, to provide installments for interested customers. The ability for a customer to purchase an item via installment may be the difference between making a sale and not making a sale, which, when compounded across a large number of customers, may have a significant impact on the merchant. Unfortunately, some issuers may not be willing to provide installments to some merchants or for some transactions where a merchant would prefer an installment be available, due to, for example, it not being in the financial interest of the issuer due to the installment terms required for customer acceptance.

In such cases, there is no recourse available for these merchants. Instead, the merchant must suffer the consequences of there being no opportunity for issuer-based installments. Some merchants may be willing to provide concessions or more favorable terms to an issuer in order to get access to these types of installments. However, there appears to be no technological systems available to provide for such a scenario. Thus, there is a need for a technical solution that can provide for converting a transaction into an installment based on an agreement between issuer and merchant and/or acquirer.

### SUMMARY

The present disclosure provides a description of systems and methods for servicing a co-funded installment. A merchant, or an acquiring institution that receives a transaction account used by the merchant to receive funds from a transaction, can enter into one or more agreements with an issuing institution regarding the conversion of transactions involving that merchant into an installment. The agreements enable merchants and issuers to agree on terms that would make an installment favorable to both parties, providing merchants the opportunity to give concessions or other considerations to an issuer to gain access to installments that might otherwise be unavailable. Because both merchant and issuer provide consideration of some type, the installment loans are considered co-funded. Of course, this would be impossible to do at a large scale of tens of thousands of potential transactions among a large number of merchants in a practical sense without the technological solution presented herein. The methods and systems discussed herein analyzes the merchant/acquirer and issuer agreements, and will automatically identify the operable, and in some cases most beneficial (e.g., if multiple agreements are applicable), agreement for a new merchant transaction and automatically identify installment terms based on that agreement, which can then be provided to the merchant, issuer, or directly to the customer for converting the transaction into an installment. The use of the system enables the conversion of transactions into installments without significant modifications to merchant or issuer systems, which is a tremendous technological advantage, for providing terms of the agreement between both entities. Thus, installments may be made available to customers when they would otherwise be prohibited and can be performed with minimal modification to existing payment systems. This has the technological advantage of being able to use a very secure network for an alternative purpose of converting an amount charged to a revolving line of credit into an installment loan in a highly automated and quick fashion.

A method for servicing a co-funded installment includes: storing, in an agreement database of a processing server, a plurality of agreement data entries, wherein each agreement data includes a structured data set related to a co-funding agreement including at least a merchant identifier, acquirer identifier, and one or more installment parameters; receiving, by a receiving device of the processing server, a transaction message for a payment transaction, wherein the transaction message is formatted according to one or more standards and includes at least a specific merchant identifier, a specific acquirer identifier, and transaction data; executing, by a querying module of the processing server, a query on the agreement database to identify at least one agreement data entry where the included merchant identifier corresponds to the specific merchant identifier and where the included acquirer identifier corresponds to the specific acquirer identifier; identifying, by a determination module of the processing server, a plurality of installment terms based on at least the transaction data and the one or more installment parameters included in one of the at least one identified agreement data entries; and electronically transmitting, by a transmitting device of the processing server, the identified plurality of installment terms.

A system for servicing a co-funded installment includes: an agreement database of a processing server configured to store a plurality of agreement data entries, wherein each agreement data includes a structured data set related to a co-funding agreement including at least a merchant identifier, acquirer identifier, and one or more installment parameters; a receiving device of the processing server configured to receive a transaction message for a payment transaction, wherein the transaction message is formatted according to one or more standards and includes at least a specific merchant identifier, a specific acquirer identifier, and transaction data; a querying module of the processing server configured to execute a query on the agreement database to identify at least one agreement data entry where the included merchant identifier corresponds to the specific merchant identifier and where the included acquirer identifier corresponds to the specific acquirer identifier; a determination module of the processing server configured to identify a plurality of installment terms based on at least the transaction data and the one or more installment parameters included in one of the at least one identified agreement data entries; and a transmitting device of the processing server configured to electronically transmit the identified plurality of installment terms.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for servicing co-funded installments in accordance with exemplary embodiments.

FIG. 2 is a block diagram illustrating the processing server of the system of FIG. 1 for the servicing of co-funded installments in accordance with exemplary embodiments.

FIGS. 3A and 3B are a flow diagram illustrating a process for the implementation and servicing of a co-funded installment using the system of FIG. 1 in accordance with exemplary embodiments.

FIG. 4 is a flow chart illustrating an exemplary method for servicing a co-funded installment in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Servicing Co-Funded Installments

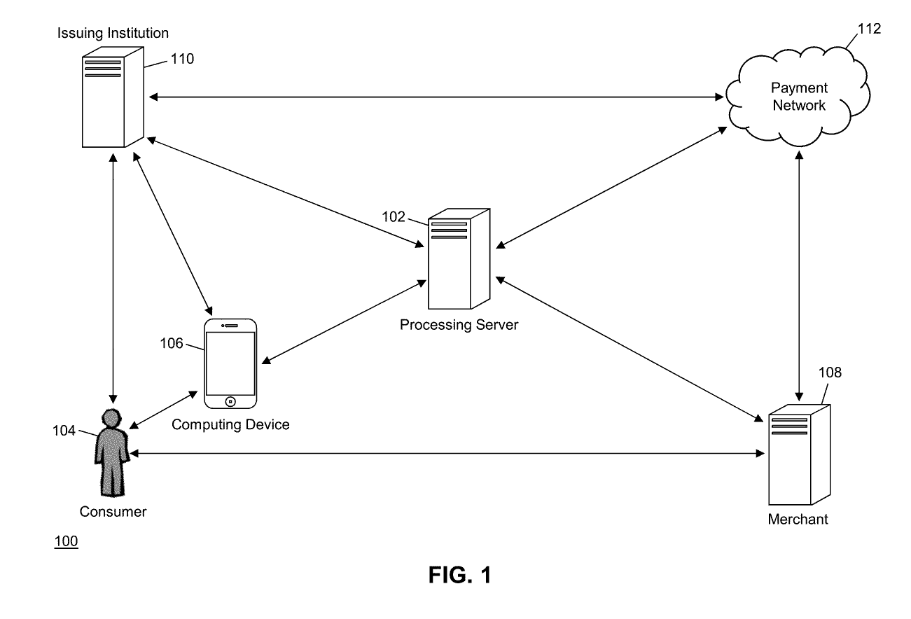

FIG. 1 illustrates a system 100 for the servicing of co-funded installments for the conversion of a merchant transaction to an installment that is subject to terms of an agreement between the issuer of a transaction account used to fund the transaction and the merchant and/or acquirer involved in the transaction.

The system 100 may include a processing server 102. The processing server 102, discussed in more detail below, may be configured to service co-funded installments for the conversion of a payment transaction between a consumer 104 and a merchant 108 into an installment that is subject to an agreement between the merchant 108 (e.g., or an acquiring institution associated with the merchant 108) and an issuing institution 110. In the system 100, the consumer 104 may be issued a transaction account by the issuing institution 110 for use in funding payment transactions. The issuing institution 110 may be a financial institution, such as an issuing bank, or any other entity configured to issue transaction accounts that may be used to fund transactions. As part of the issuing of the transaction account, the issuing institution 110 may issue an account number and other payment credentials to the consumer 104, often via a payment instrument, that the consumer 104 may present to a merchant 108 to pay for a proposed transaction with the issued transaction account.

In an effort to provide consumers 104 with the opportunity to convert transactions at a merchant 108 into an installment, the merchant 108 and issuing institution 110 may enter into an agreement, typically before a particular transaction but can be concurrently. As discussed herein, “merchant” may also refer to an acquiring financial institution acting on behalf of or in place of the merchant 108. The agreement may and typically does specify installment terms for any installment that is generated via a converted merchant transaction, and may also specify any other criteria that must be fulfilled by the merchant 108 and/or issuing institution 110 with respect to the installment. Installment terms may include, for instance, number of payments, period of payments, interest rate, transaction amount, period of repayment, service fees, any minimums or maximums thereof, and any other terms that may be applicable as will be apparent to persons having skill in the relevant art. The other criteria may include any consideration that the merchant 108 or issuing institution 110 may be interested in. In an example, a merchant 108 and issuing institution 110 may agree on a set of installment terms for converting transactions to installments provided that the merchant 108 pays the interest on any converted installment. In another example, the agreement may stipulate a maximum number of installment payments acceptable by the issuing institution 110 where the merchant 108 is responsible for any additional installment payments (e.g., where the merchant 108 may be willing to cover the additional payments to guarantee a consumer's acceptance of an installment for a transaction that may otherwise be abandoned).

When an agreement is made, the merchant 108 and/or the issuing institution 110 may provide the agreement or data associated therewith to the processing server 102. The appropriate entity may electronically transmit a data signal to the processing server 102 using a suitable communication method where the data signal is superimposed or otherwise encoded with the agreement data. In some cases, the processing server 102 may provide an application programming interface (API) or other suitable method for submission of agreement data thereto. The processing server 102 may be configured to store data associated with agreements entered into by an issuing institution 110 and merchant 108 that are received therefrom. The processing server 102 may store at least the installment terms stipulated in the agreement that may be applicable to a submitted merchant transaction that can be eligible for conversion. In some cases, the processing server 102 may also store additional criteria included in the agreement or, in some instances, the full content of the agreement itself. In other cases, the processing server 102 may only be provided with the installment terms and information identifying the operating entities (e.g., issuing institution 110 and merchant 108 and/or acquirer). Such data may be provided by the merchant 108 or the issuing institution 110. In some cases, the processing server 102 may require verification by the other entity to ensure that the installment terms and any other data is accurate. In some instances, the processing server 102 may receive the full agreement or portions thereof, and may be configured to parse the appropriate data therefrom, such as via the use of text recognition and other suitable techniques. In other instances, a platform or interface may be provided by the processing server 102 for the input of the agreement data to be used herein. For example, the merchant 108 or issuing institution 110 may separately input each of the installment parameters, such as through the use of drop-down menus (e.g., to select a parameter), input fields (e.g., to supply a value), checkboxes (e.g., for multiple options for a parameter), and other interface elements.

The processing server 102 may also receive any additional data regarding the applicability of an agreement. Such data may include, for instance, operating dates, geographic locations, transaction amounts, product identifiers, product categories, etc. For instance, in one example, an agreement may only be applicable during a certain period of time or in a certain jurisdiction. In another example, an issuing institution 110 and merchant 108 may have one agreement applicable to any transaction at that merchant that is funded via one of the issuer's transaction accounts, while a second agreement (e.g., with more favorable terms to the consumer 104) may be applicable to transactions above a certain transaction amount or involving products of a certain category.

The processing server 102 may store the agreement data in an agreement database, discussed in more detail below. In addition to the installment parameters and any additional data, the agreement data may include at least an identification value associated with the merchant 108, an identification value associated with the acquirer associated with the merchant 108, and an identification value associated with the issuing institution 110. Each identification value may be a unique value that is suitable for use in identifying the associated entity. For instance, the unique identifier for the merchant 108 may be a merchant identification number, while the unique identifiers for the issuing institution 110 and acquirer may be a bank identification number or issuer identification number.

In the system 100, the consumer 104 may initiate a payment transaction with a merchant 108. The merchant 108 may submit the payment transaction for processing, such as by electronically transmitting transaction data for the payment transaction to its acquirer, which may then generate and submit a transaction message for the payment transaction to a payment network 112 via payment rails associated therewith. The transaction message may be a specially formatted data message that is formatted according to one or more standards governing the exchange of financial transaction messages, such as the International Organization of Standardization's ISO 8583 or ISO 20022 standards. The transaction message may include a plurality of data elements, where each data element is configured to store transaction data. Transaction data may include any data used in the processing of the payment transaction, such as a transaction time, transaction date, transaction amount, geographic location, currency, transaction type, point of sale identifier, merchant identifier, acquirer identifier, account number, product data, reward data, offer data, loyalty data, etc. The payment network 112 may receive the transaction message and may process the transaction message using traditional methods and systems.

As part of the processing of the payment transaction, the transaction message may be forwarded to the processing server 102 to identify any applicable installment agreement and apply it to the payment transaction. In some embodiments, the processing server 102 may be configured to perform these functions prior to approval or denial of the payment transaction by the issuing institution 110. In these embodiments, the transaction message may be forwarded to the processing server 102 by the merchant 108 or acquirer prior to submission to the payment network 112, by the payment network 112 following receipt from the acquirer, or by the issuing institution 110 following receipt from the payment network 112. In other embodiments, the payment transaction may be approved as a standard merchant transaction prior to the performance of the above functions by the processing server 102. In these embodiments, the transaction message may be forwarded to the processing server 102 by the issuing institution 110 after approval or the transaction or following the completion of processing of the payment transaction, or by the payment network 112 upon the receipt of an authorization response for the payment transaction from the issuing institution 110. In some embodiments, the processing server 102 may be a part of the systems of the merchant 108, issuing institution 110, or payment network 112. In such embodiments, the processing server 102 may receive the transaction message via internal communications of the respective entity, as applicable.

The processing server 102 may receive the transaction message and may identify if there are any applicable agreements. The identification may be based on querying the agreement database to identify any agreements between the issuing institution 110 that issued the transaction account to be used in the payment transaction (e.g., based on the bank identification number or other identification value included therein, such as parsed from the account number) and the merchant 108 involved in the payment transaction (e.g., based on the merchant identifier included in the transaction message), and, if applicable, the acquirer for the merchant 108 (e.g., identified via an acquirer identifier included in the transaction message). If a potentially applicable agreement is identified (e.g., one between the merchant 108 and issuing institution 110 involved in the transaction), then the processing server 102 may determine if any other parameters of the agreement need to be considered for applicability. For example, if an agreement requires a minimum transaction amount or specifies dates of applicability, the processing server 102 may evaluate the applicability of the agreement to the transaction based on the transaction data included in the transaction message.

In some cases, multiple applicable agreements may be identified. In such cases, the processing server 102 may be configured to identify which agreement will operate for the conversion of the merchant transaction to an installment. In some cases, the operating agreement may be based on terms of each agreement as may be specified by the merchant 108 and/or issuing institution 110 (e.g., an entity may specify priorities for each agreement). In other cases, the operating agreement may be identified by the processing server 102 based on the installment terms, which the processing server 102 may select based on the terms that may be most favorable to the consumer 104. For example, the operating agreement may be the agreement with the lowest overall repayment amount or the lowest interest rate. In some cases, the consumer 104 may provide preferences for the selection of an operating agreement. For example, a consumer 104 may specify that they prefer the lowest interest rate, lowest number of repayments, longest repayment period, etc.

If no applicable agreement is identified, then the processing server 102 may notify the appropriate entity (e.g., that forwarded the transaction message) and the processing of the payment transaction may be continued as normal. If an applicable and operating agreement is identified, then the processing server 102 may identify installment terms for a converted installment for the merchant transaction. The installment terms may be based on any installment parameters included in the identified agreement, in addition to the transaction data included in the transaction message. In some cases, the installment terms may be a single set of terms. In other cases, the installment terms may include ranges or multiple options for one or more terms (e.g., three different choices for number of payments and subsequently different interest rates and payment amounts). Once the terms have been identified, they may be transmitted out by the processing server 102.

In one embodiment, the processing server 102 may provide the installment terms directly to the consumer 104. In such an embodiment, the processing server 102 may have communication data associated with the consumer 104, such as for a registered consumer where it may be identified based on data included in the transaction message, such as the account number, loyalty number, etc. The processing server 102 may then communicate with the consumer 104 using the communication data, such as by electronically transmitting the identified installment terms to the consumer 104 via a computing device 106 associated therewith (e.g., specified in the communication data). For example, the communication data may include a media access control address, internet protocol address, telephone number, email address, etc. that may be used to contact the consumer 104 via the computing device 106. The computing device 106 may be any type of computing device suitable for performing the functions discussed herein, such as a desktop computer, laptop computer, notebook computer, tablet computer, cellular phone, smart phone, wearable computing device, implantable computing device, smart television, smart watch, etc.

The consumer 104 may view the proposed installment terms on their computing device 106 and may determine whether to accept or decline conversion of the merchant transaction into the installment plan based on the terms. In cases where multiple choices of terms may be provided, the consumer 104 may be able to view each choice and may select one of the choices if they wish to accept the conversion. The consumer 104 may, using the computing device 106, communicate their acceptance or decline of the installment terms back to the processing server 102. The processing server 102 may then provide the consumer's acceptance and the accepted installment terms to the issuing institution 110 using a suitable communication method. In some embodiments, the consumer 104 may communicate their acceptance or decline directly to the issuing institution 110. In such cases, the acceptance or decline may be accompanied by the installment terms being accepted as provided by the processing server 102.

In some embodiments, the installment terms may be presented to the consumer 104 by the issuing institution 110. In such embodiments, when the processing server 102 determines the installment terms (e.g., or choices thereof), the processing server 102 may communicate the installment terms to the issuing institution 110. For instance, the processing server 102 may electronically transmit a data message to the issuing institution 110 via a suitable communication method that includes the installment terms and may, in some instances, include information identifying the merchant transaction or transaction data associated therewith. In other instances, the processing server 102 may include the installment terms in the transaction message for the payment transaction prior to forwarding the transaction message to the issuing institution 110 for processing. In some such instances, the installment terms may accompany the transaction message in the transmission to the issuing institution 110 rather than be stored directly in the transaction message. The issuing institution 110 may then be free to contact the consumer 104 for acceptance or declining of the installment terms using traditional methods.

Once the issuing institution 110 has been informed of the acceptance and accepted installment terms, the issuing institution 110 may perform traditional actions for conversion of the merchant transaction into an installment. For instance, in cases where the initial merchant transaction may be processed prior to conversion, the issuing institution 110 may credit the consumer's transaction account for the transaction amount and debit only the first installment payment. In cases where the initial merchant transaction was not processed, the authorization for the transaction may be made for only the first installment amount. It will be apparent to persons having skill in the relevant art that the processing of the conversion of the merchant transaction to the installment terms may vary depending on the terms of the agreement between the issuing institution 110 and the merchant 108.

The methods and systems discussed herein enable a merchant transaction to be converted into an installment plan by an issuing institution 110 while remaining subject to an agreement between the merchant 108 (e.g., and/or an acquirer associated therewith) and the issuing institution 110. The processing server 102 is specially configured to determine applicability of such an agreement to a transaction, and, if applicable, determine installment terms based on the parameters included in the agreement. The result is that a merchant transaction may be converted into an installment plan pursuant to an agreement between the parties without any significant modification to the systems of merchants 108, issuing institutions 110, or payment networks 112. Thus, co-funded installments may be implemented into existing payment systems with little to no modifications thereof due to the technological solution provided by the processing server 102 and the methods and systems discussed herein.

### Processing Server

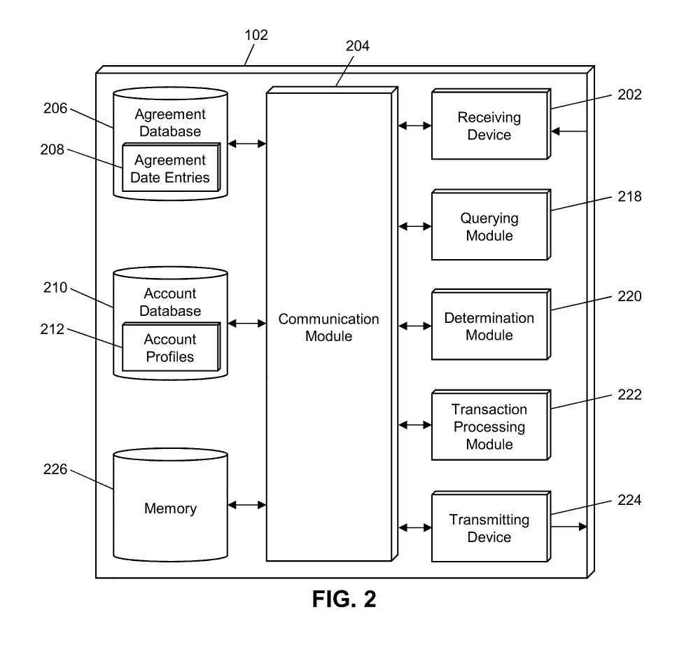

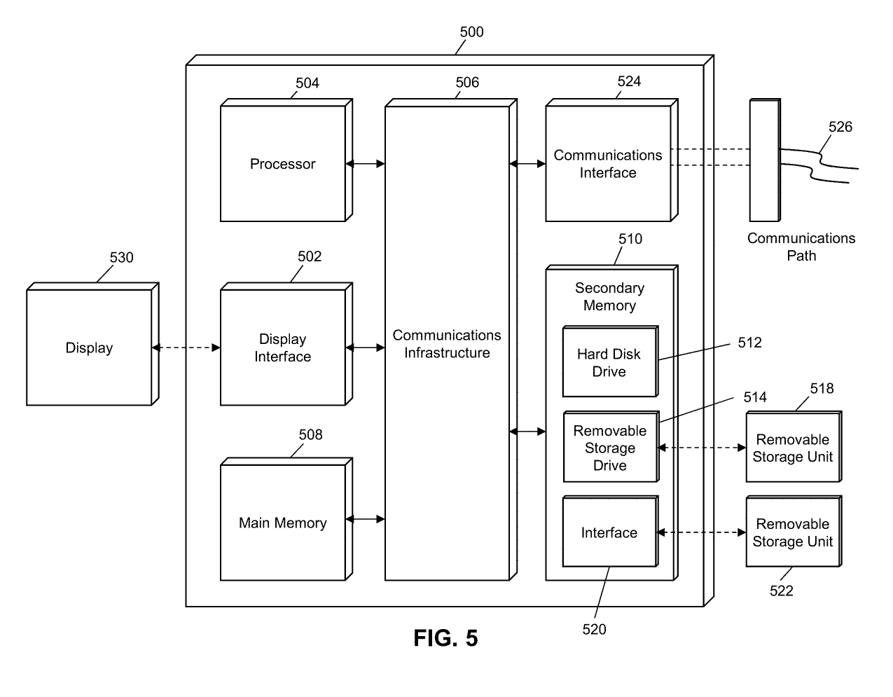

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 500 illustrated in FIG. 5 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from computing devices 106, merchants 108, issuing institutions 110, payment networks 112, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by merchants 108 and issuing institutions 110 that may be superimposed or otherwise encoded with agreement data, which may include at least an issuer identifier, merchant identifier, acquirer identifier, and installment parameters, and may also include applicability data, agreement terms, and other data as discussed herein. The receiving device 202 may also be configured to receive data signals superimposed or otherwise encoded with transaction messages, which may be electronically transmitted by issuing institutions 11 or merchants 108 or may be transmitted by payment networks 112, which may utilize payment rails associated therewith. Transaction messages may be specially formatted data messages that include data elements configured to store transaction data. The receiving device 202 may also be configured to receive data signals electronically transmitted by computing devices 106, which may be superimposed or otherwise encoded with installment term acceptances or declines, selections of installment terms, user preferences for installments, communication data, etc.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 218, determination module 220, transaction processing module 222, etc. As used herein, the term “module” may be software or hardware particularly programmed to receive an input, perform one or more processes using the input, and provides an output. The input, output, and processes performed by various modules will be apparent to one skilled in the art based upon the present disclosure.

In some embodiments, the processing server 102 may include an agreement database 206. The agreement database 206 may be configured to store a plurality of agreement data entries 208 using a suitable data storage format and schema. The agreement database 206 may be a relational database that utilizes structured query language for the storage, identification, modifying, updating, accessing, etc. of structured data sets stored therein. Each agreement data entry 208 may be a structured data set configured to store data related to a co-funding installment agreement. An agreement data entry 208 may include at least a merchant identifier and acquirer identifier associated with entities involved in the agreement with an issuing institution 110, as well as one or more installment parameters that may be used to determine or otherwise affect terms of a potential installment. In some cases an agreement data entry 208 may also include an issuer identifier, applicability rules or criteria, and other data associated with the related agreement.

In some embodiments, the processing server 102 may include an account database 210. The account database 210 may be configured to store a plurality of account profiles 212 using a suitable data storage format and schema. The account database 210 may be a relational database that utilizes structured query language for the storage, identification, modifying, updating, accessing, etc. of structured data sets stored therein. Each account profile 212 may be a structured data set configured to store data related to a transaction account including at least an account identifier and communication data. The account identifier may be a unique identification value used to identify the account profile 212, and may be included in or otherwise parsed from a transaction message, such as an account number, e-mail address, telephone number, device identifier, etc. The communication data may include any data suitable for use by the processing server 102 in contacting the consumer 104 via a computing device 106, such as a communication method and address. In some embodiments, an account profile 212 may also include user preferences, which may be set by the related consumer 104 and used to select an operating agreement from a set of multiple, applicable installment agreements. For example, user preferences may include preferred interest rates, number of payments, repayment periods, or other criteria that may be used to determine what installment agreement may be most preferable to the consumer 104 involved in a merchant transaction that is eligible for conversion to an installment.

The processing server 102 may include a querying module 218. The querying module 218 may be configured to execute queries on databases to identify information. The querying module 218 may receive one or more data values or query strings, and may execute a query string based thereon on an indicated database, such as the agreement database 206, to identify information stored therein. The querying module 218 may then output the identified information to an appropriate engine or module of the processing server 102 as necessary. The querying module 218 may, for example, execute a query on the agreement database 206 to identify one or more agreement data entries 208 for agreements potentially applicable to a merchant transaction based on a correspondence between merchant and acquirer identifiers in the agreement data entry 208 and a merchant identifier and acquirer identifier in a transaction message received for the merchant transaction.

The processing server 102 may also include a determination module 220. The determination module 220 may be configured to make determinations for the processing server 102 as part of the functions discussed herein. The determination module 220 may receive an instruction as input, may make a determination as instructed, and may output a result of the determination to another module or engine of the processing server 102. In some cases, the input may include data to be used in the determination. In some instances, the determination module 220 may be configured to identify additional data to be used, such as in the account database 210 or a memory 226 of the processing server 102. The determination module 220 may be configured to, for example, determine installment terms for a merchant transaction based on the transaction data and the installment parameters of an applicable agreement, such as may be identified in the associated agreement data entry 208. In cases where multiple agreements may be applicable, the determination module 220 may be configured to determine an operating agreement based on the installment terms, transaction data, user preferences, or any other suitable data.

The processing server 102 may also include a transaction processing module 222. The transaction processing module 222 may be configured to perform functions associated with the processing of transactions as part of the processing server 102 as discussed herein. For example, the transaction processing module 222 may be configured to route transaction messages, determine approval or denial of payment transactions using traditional methods, map account numbers, apply discounts to a payment transaction, etc.

The processing server 102 may also include a transmitting device 224. The transmitting device 224 may be configured to transmit data over one or more networks via one or more network protocols. In some instances, the transmitting device 224 may be configured to transmit data to computing devices 106, merchants 108, issuing institutions 110, payment networks 112, and other entities via one or more communication methods, local area networks, wireless area networks, cellular communication, Bluetooth, radio frequency, the Internet, etc. In some embodiments, the transmitting device 224 may be comprised of multiple devices, such as different transmitting devices for transmitting data over different networks, such as a first transmitting device for transmitting data over a local area network and a second transmitting device for transmitting data via the Internet. The transmitting device 224 may electronically transmit data signals that have data superimposed that may be parsed by a receiving computing device. In some instances, the transmitting device 224 may include one or more modules for superimposing, encoding, or otherwise formatting data into data signals suitable for transmission.

The transmitting device 224 may be configured to electronically transmit data signals to computing devices 106, which may be superimposed or otherwise encoded with one of more sets of installment terms. The transmitting device 224 may also be configured to electronically transmit data signals to issuing institutions 110, which may be superimposed or otherwise encoded with an account and/or transaction identifier and selected installment terms as accepted by a consumer 104, or one or more sets of installment terms for a proposed converted merchant transaction based on an operating agreement. The transmitting device 224 may also be configured to electronically transmit data signals to merchants 108, issuing institutions 110, and payment networks 112 that may be superimposed or otherwise encoded with transaction messages and other data suitable for use in the processing of merchant transactions and installment transactions.

The processing server 102 may also include a memory 226. The memory 226 may be configured to store data for use by the processing server 102 in performing the functions discussed herein, such as public and private keys, symmetric keys, etc. The memory 226 may be configured to store data using suitable data formatting methods and schema and may be any suitable type of memory, such as read-only memory, random access memory, etc. The memory 226 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 226 may be comprised of or may otherwise include a relational database that utilizes structured query language for the storage, identification, modifying, updating, accessing, etc. of structured data sets stored therein. The memory 226 may be configured to store, for example, algorithms for installment calculations, communication information and protocols, etc.

### Process for Servicing of a Co-Funded Installment Agreement

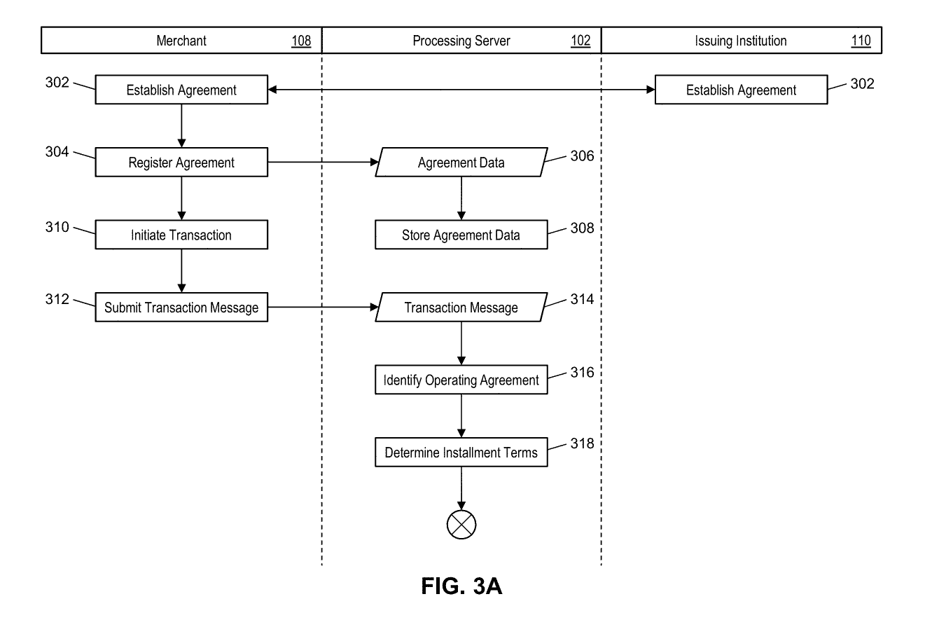

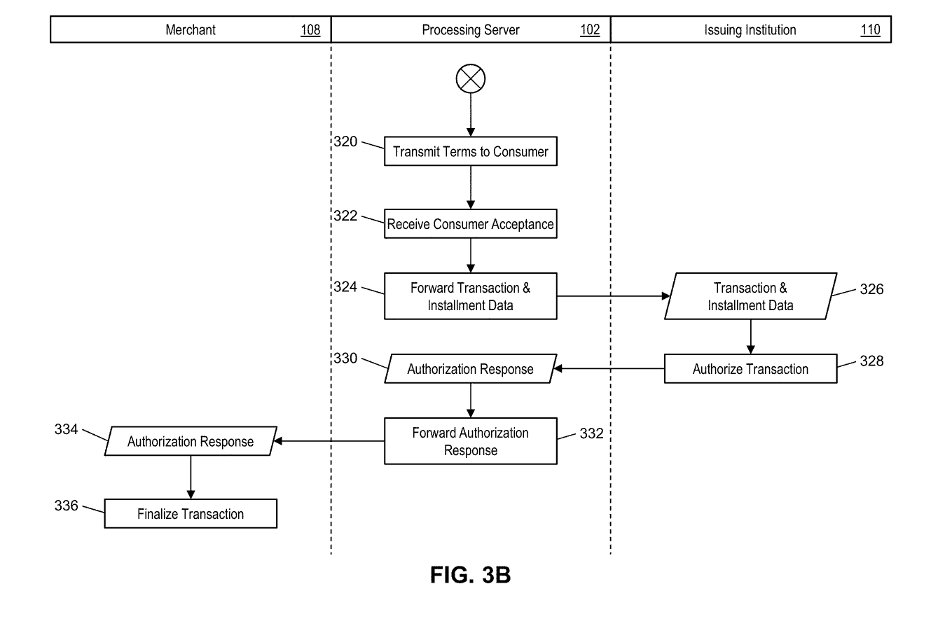

FIGS. 3A and 3B illustrate a process in the system 100 for the servicing of the conversion from a merchant transaction to an installment plan based on a co-funding agreement between the issuing institution 110 and merchant 108.

In step 302, the merchant 108 and the issuing institution 110 may enter into an agreement regarding the conversion of transactions involving the merchant 108 to installments. The agreement may include one or more installment parameters, which may govern installment terms, such as by setting rules regarding acceptable terms, how terms are determined, etc. The agreement may also include stipulations or consideration of the merchant 108 or issuing institution 110, and, in some cases, may also include applicability rules for determining the applicability of the agreement to a merchant transaction. In step 304, the merchant 108 may register the agreement with the processing server 102, such as by electronically transmitting the agreement data to the processing server 102 via a suitable communication method.

In step 306, the receiving device 202 of the processing server 102 may receive the agreement data. The agreement data may include at least the merchant identifier associated with the merchant 108, an acquirer identifier associated with an acquirer related to the merchant 108, and the installment parameters. In some cases, the agreement data may include any additional data suitable for performing the functions discussed herein, such as the applicability rules (e.g., start and end dates), agreement type, etc. In some embodiments, the processing server 102 may be configured to parse the agreement data from text of the agreement itself to obtain the identifiers, installment parameters, and any other data. In other embodiments, the agreement data may be registered in a format where the installment parameters, identifiers, and any other data are pre-parsed or provided separately, such as through an API where each value is supplied specifically. In step 308, the querying module 218 may execute a query on the agreement database 206 to insert a new agreement data entry 208 that includes the received agreement data.

In step 310, the merchant 108 may initiate a transaction with a consumer 104. The initiation of the transaction may include the collection and input of transaction data, which may include at least a transaction amount, a merchant identifier associated with the merchant 108, and an acquirer identifier associated with the acquirer that issued the transaction account used by the merchant 108 to receive funds. In step 312, the merchant 108 may submit the transaction data for the payment transaction to the payment network 112, which may be formatted by the merchant 108 in a transaction message or provided to an acquirer or other intermediate entity for formatting as a transaction message and forwarding to the payment network 112. In step 314, the receiving device 202 of the processing server 102 may receive the transaction message from the payment network 112 (e.g., or issuing institution 110 or acquirer, as applicable).

In step 316, the querying module 218 of the processing server 102 may identify an operating agreement for the merchant transaction by executing a query on the agreement database 206 to identify an agreement data entry 208 where the included merchant and acquirer identifiers match the merchant and acquirer identifiers included in the transaction data. In cases where multiple agreement data entries 208 may be suitable, the determination module 220 of the processing server 102 may be configured to identify one of the agreement data entries 208 as related to the agreement for use in the converted installment based on applicability rules, user preferences, agreement parameters, or other suitable data as discussed herein. In step 318, the determination module 220 of the processing server 102 may determine installment terms for the proposed converted installment based on the one or more installment parameters included in the identified agreement data entry 208 and the transaction data. In some cases, multiple sets of installment terms may be identified for selection by the consumer 104 involved in the merchant transaction.

In step 320, the transmitting device 224 of the processing server 102 may electronically transmit a data message to the computing device 106 associated with the consumer 104 that includes the determined installment terms. In some cases, data for communicating with the computing device 106 may be identified via the execution of a query on the account database 210 by the querying module 218 of the processing server 102 to identify an account profile 212 that includes an account identifier included in the transaction data. The consumer 104 may receive the installment terms via the computing device 106 and accept a set of installment terms using the computing device 106. In step 322, the receiving device 202 of the processing server 102 may receive the consumer's acceptance from the computing device 106, which may indicate the installment terms that are accepted.

In step 324, the transmitting device 224 may electronically transmit the transaction message and the accepted installment terms to the issuing institution 110 using a suitable communication method. In step 326, the issuing institution 110 may receive the transaction data and accepted installment terms. In step 328, the issuing institution 110 may authorize the conversion of the merchant transaction into installments with the specified installment terms using traditional methods. As part of the authorization, the issuing institution 110 may generate a transaction message indicated as an authorization response that is transmitted to the processing server 102, where the authorization response includes an indication of approval of the converted installment transaction. In step 330, the receiving device 202 of the processing server 102 may receive the authorization response.

In step 332, the transmitting device 224 of the processing server 102 may electronically transmit the authorization response to the merchant 108 (e.g., through the payment network 112, acquirer, or any other intermediate entities). In step 334, the merchant 108 may receive the authorization response. In step 336, the merchant 108 may finalize the transaction, such as by furnishing the consumer 104 with the transacted for goods or services.

### Exemplary Method for Servicing a Co-Funded Installment

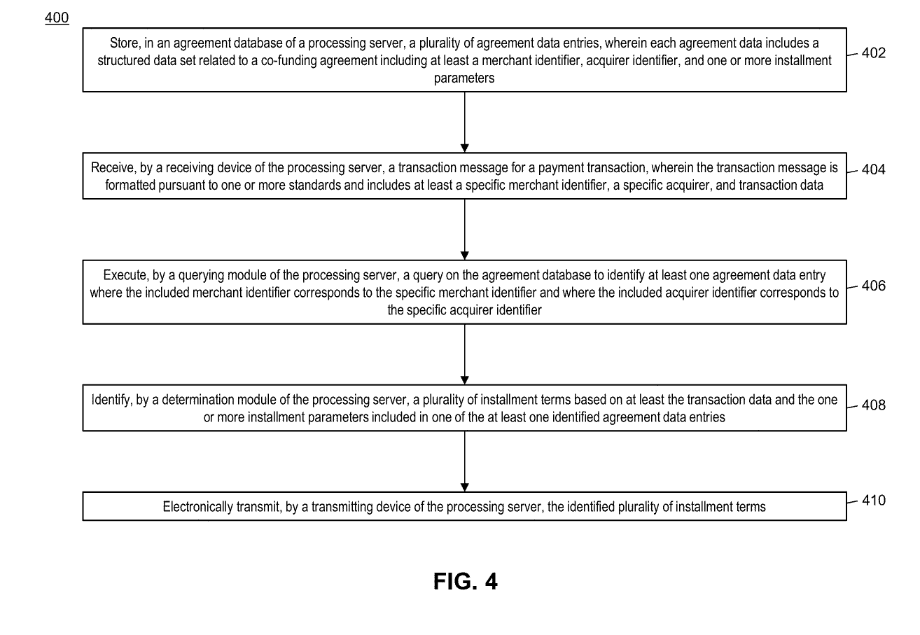

FIG. 4 illustrates a method 400 for the servicing of a co-funded installment by identifying an agreement between parties involved in a merchant transaction applicable to the transaction and identifying installment terms based thereon.

In step 402, a plurality of agreement data entries (e.g., agreement data entries 208) may be stored in an agreement database (e.g., the agreement database 206) of a processing server (e.g., the processing server 102), wherein each agreement data includes a structured data set related to a co-funding agreement including at least a merchant identifier, acquirer identifier, and one or more installment parameters. In step 404, a transaction message for a payment transaction may be received by a receiving device (e.g., the receiving device 202) of the processing server, wherein the transaction message is formatted according to one or more standards and includes at least a specific merchant identifier, a specific acquirer identifier, and transaction data.

In step 406, a query may be executed on the agreement database by a querying module (e.g., the querying module 218) of the processing server to identify at least one agreement data entry where the included merchant identifier corresponds to the specific merchant identifier and where the included acquirer identifier corresponds to the specific acquirer identifier. In step 408, a plurality of installment terms may be identified by a determination module (e.g., the determination module 220) of the processing server based on at least the transaction data and the one or more installment parameters included in one of the at least one identified agreement data entries. In step 410, the identified plurality of installment terms may be electronically transmitted by a transmitting device (e.g., the transmitting device 224) of the processing server.

In one embodiment, the method 400 may further include determining, by the determination module of the processing server, an operating agreement data entry of the at least one identified agreement data entries based on at least the one or more installment parameters included in each of the at least one identified agreement data entries. In a further embodiment, the method 400 may also include storing, in an account database (e.g., the account database 210) of the processing server, an account profile (e.g., an account profile 212), wherein the account profile includes a structured data set related to a transaction account including at least an account number and one or more user preferences, wherein the transaction data includes the account number, and determination of the operating agreement data entry is further based on a comparison of the one or more user preferences to the one or more installment parameters included in each of the at least one identified agreement data entries. In some embodiments, each agreement data entry may further include a start date and an end date, the transaction data may include at least a transaction date, and determination of the operating agreement data entry may be further based on a comparison of the transaction date and the start date and end date included in each of the at least one identified agreement data entries.

In one embodiment, the identified plurality of installment terms may be electronically transmitted to an issuing financial institution (e.g., the issuing institution 110) indicated in the transaction data included in the received transaction message. In a further embodiment, the plurality of installment terms may be stored in the received transaction message, and electronically transmitting the identified plurality of installment terms to the issuing financial institution may include transmitting the received transaction message to the issuing financial institution. In some embodiments, the identified plurality of installment terms may be electronically transmitted to a computing device (e.g., the computing device 106) associated with a transaction account indicated in the transaction data included in the received transaction message. In a further embodiment, the method 400 may even further include receiving, by the receiving device of the processing server, an indication of approval or denial of the plurality of installment terms from the computing device; and electronically transmitting, by the transmitting device of the processing server, the identified plurality of installment terms and indication of approval or denial to an issuing financial institution associated with the transaction account.

### Computer System Architecture

FIG. 5 illustrates a computer system 500 in which embodiments of the present disclosure, or portions thereof, may be implemented as computer-readable code. For example, the processing server 102 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3A, 3B, and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3A, 3B, and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for servicing co-funded installments. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for servicing a co-funded installment, comprising:
storing, in an agreement database of a processing server, a plurality of agreement data entries, wherein each agreement data includes a structured data set related to a co-funding agreement including at least a merchant identifier, acquirer identifier, and one or more installment parameters;
receiving, by a receiving device of the processing server, a transaction message for a payment transaction, wherein the transaction message is formatted according to one or more standards and includes at least a specific merchant identifier, a specific acquirer identifier, and transaction data;
executing, by a querying module of the processing server, a query on the agreement database to identify at least one agreement data entry where the included merchant identifier corresponds to the specific merchant identifier and where the included acquirer identifier corresponds to the specific acquirer identifier;
identifying, by a determination module of the processing server, a plurality of installment terms based on at least the transaction data and the one or more installment parameters included in one of the at least one identified agreement data entries; and
electronically transmitting, by a transmitting device of the processing server, the identified plurality of installment terms.

2. The method of claim 1, further comprising:
determining, by the determination module of the processing server, an operating agreement data entry of the at least one identified agreement data entries based on at least the one or more installment parameters included in each of the at least one identified agreement data entries.

3. The method of claim 2, further comprising:
storing, in an account database of the processing server, an account profile, wherein the account profile includes a structured data set related to a transaction account including at least an account number and one or more user preferences, wherein
the transaction data includes the account number, and
determination of the operating agreement data entry is further based on a comparison of the one or more user preferences to the one or more installment parameters included in each of the at least one identified agreement data entries.

4. The method of claim 1, wherein
each agreement data entry further includes a start date and an end date,
the transaction data includes at least a transaction date, and
determination of the operating agreement data entry is further based on a comparison of the transaction date and the start date and end date included in each of the at least one identified agreement data entries.

5. The method of claim 1, wherein the identified plurality of installment terms are electronically transmitted to an issuing financial institution indicated in the transaction data included in the received transaction message.

6. The method of claim 5, wherein
the plurality of installment terms are stored in the received transaction message, and
electronically transmitting the identified plurality of installment terms to the issuing financial institution includes transmitting the received transaction message to the issuing financial institution.

7. The method of claim 1, wherein the identified plurality of installment terms are electronically transmitted to a computing device associated with a transaction account indicated in the transaction data included in the received transaction message.

8. The method of claim 7, further comprising:
receiving, by the receiving device of the processing server, an indication of approval or denial of the plurality of installment terms from the computing device; and
electronically transmitting, by the transmitting device of the processing server, the identified plurality of installment terms and indication of approval or denial to an issuing financial institution associated with the transaction account.

9. A system for servicing a co-funded installment, comprising:
an agreement database of a processing server configured to store a plurality of agreement data entries, wherein each agreement data includes a structured data set related to a co-funding agreement including at least a merchant identifier, acquirer identifier, and one or more installment parameters;
a receiving device of the processing server configured to receive a transaction message for a payment transaction, wherein the transaction message is formatted according to one or more standards and includes at least a specific merchant identifier, a specific acquirer identifier, and transaction data;
a querying module of the processing server configured to execute a query on the agreement database to identify at least one agreement data entry where the included merchant identifier corresponds to the specific merchant identifier and where the included acquirer identifier corresponds to the specific acquirer identifier;
a determination module of the processing server configured to identify a plurality of installment terms based on at least the transaction data and the one or more installment parameters included in one of the at least one identified agreement data entries; and
a transmitting device of the processing server configured to electronically transmit the identified plurality of installment terms.

10. The system of claim 9, wherein the determination module of the processing server is further configured to determine an operating agreement data entry of the at least one identified agreement data entries based on at least the one or more installment parameters included in each of the at least one identified agreement data entries.

11. The system of claim 10, further comprising:
an account database of the processing server configured to store an account profile, wherein the account profile includes a structured data set related to a transaction account including at least an account number and one or more user preferences, wherein
the transaction data includes the account number, and
determination of the operating agreement data entry is further based on a comparison of the one or more user preferences to the one or more installment parameters included in each of the at least one identified agreement data entries.

12. The system of claim 9, wherein
each agreement data entry further includes a start date and an end date,
the transaction data includes at least a transaction date, and
determination of the operating agreement data entry is further based on a comparison of the transaction date and the start date and end date included in each of the at least one identified agreement data entries.

13. The system of claim 9, wherein the identified plurality of installment terms are electronically transmitted to an issuing financial institution indicated in the transaction data included in the received transaction message.

14. The system of claim 13, wherein
the plurality of installment terms are stored in the received transaction message, and
electronically transmitting the identified plurality of installment terms to the issuing financial institution includes transmitting the received transaction message to the issuing financial institution.

15. The system of claim 9, wherein the identified plurality of installment terms are electronically transmitted to a computing device associated with a transaction account indicated in the transaction data included in the received transaction message.

16. The system of claim 15, wherein
the receiving device of the processing server is further configured to receive an indication of approval or denial of the plurality of installment terms from the computing device, and
the transmitting device of the processing server is further configured to electronically transmit the identified plurality of installment terms and indication of approval or denial to an issuing financial institution associated with the transaction account.
